(19) United States
(12) Patent Application Publication
(10) Pub. No.: US 2009/0198515 A1
(43) Pub. Date: Aug. 6, 2009

(54) ORGANIZATION METHOD AND SYSTEM FOR HEALTH INFORMATION

(76) Inventor: Amrita G. Sawhney, Montclair, NJ (US)

Correspondence Address: DICKINSON WRIGHT PLLC, 1875 Eye Street, NW, Suite 1200, WASHINGTON, DC, 20006, US

(21) Appl. No.: 12/026,007

(22) Filed: Feb. 5, 2008

(51) Int. Cl. G06Q 50/00; G06Q 10/00

(52) U.S. Cl. 705/3; 705/2

(57) ABSTRACT

A health information and health record organization system. The system is designed for use by a consumer and their physician, dentist, optometrist, veterinarian, and other health care provider. The invention can have a paper and an electronic component and carrying case for radiology films, pathology slides, and CDs. A web-based portion can allow the user to enter particular information to be kept on their person for emergency use. Embodiments for the system can include systems for humans and animals.

### FIELD OF THE INVENTION

The present invention generally relates to a system and method of organizing records and, more specifically, to a personal organization system for health care records for humans and animals.

### BACKGROUND OF INVENTION

“Health care” is a very general term that can include a wide array of services to humans and animals. In an era of ever-increasing sophistication and technological advancement, health care for humans and animals has become increasingly complex. This trend is likely to continue. For the layperson and professional alike, management of health care records is also becoming increasingly complex.

It is important for a patient and a health care provider to have as much patient information as possible to optimize treatment and management. Health care records are an important aspect of this process and can include appointment histories, photographic data, medical histories, dental histories, eye histories, allergy information, medications, therapies, immunization data, interventions, growth data, surgical history, hospitalization data, emergency room visit data, identification data involving micro-chips and other electronic systems, family history, legal authority for medical care, bills, laboratory results, radiology data, pathology slides and tissues, test reports, consultation notes, categorization by specialist, adoptive history, and the like.

Also, health care worker or patient-generated information forms may be developed beyond direct medical care, such as information to easily track all appointments and interventions, focus sheets to allow consumers to preplan their visit and then keep track of recommendations, electronic web-based summaries of particular data, and other information generated as a result of the interaction between the health care provider and user of the present invention. For animals or pets, information beyond direct medical care may additionally include breed and species data and show animal records.

Records developed to record all these various types of information are often as varied as the treatment themselves. Also, the storage media of information may vary by geographic regions. For example, X-ray films from a patient from an undeveloped country would be quite different from the digital images now used in many research-based tertiary care centers.

Without an individualized system or method for tracking and physically managing health care-related information, valuable data may be lost or overlooked. This could lead to repeat testing, wasted time and resources and, potentially, sub-optimal health care. Despite the vital importance of all these records in all these formats, there is often very little effort on the part of the patient or the health care provider to organize them in an accurate, complete, and efficient manner. Such a system is desirable, given the improved health care that could be provided.

There are known attempts in the art to improve the documentation of health-related information. For example, U.S. Pat. No. 4,865,549 to Sonsteby and U.S. Pat. No. 5,452,808 to Abramowitz disclose a simple documentation system, but fail to address the needs of organization of current types of medical records and/or information. The same is generally true for U.S. Pat. Nos. 2,713,531; 3,472,387; 4,041,893, and US App. No. 20010045737 to Mathew G. Hudkins.

Despite attempts, the prior art fails to provide optimal health care for several reasons. None address the current data advancements in electronic or web-based document creation, retention, and distribution. Also, none address the information needed specifically for animals or other valuable information needed beyond medical information. Thus, there is a desire and a need in the art to provide a method and system for the average consumer to develop, store, and maintain health care records and the like that successfully and efficiently utilizes current technologies.

### BRIEF DESCRIPTION OF THE FIGURES

The foregoing features, as well as other features, will become apparent with reference to the description and figures below, in which like numerals represent like elements, and in which:

FIG. 1 illustrates a completed assembly of one embodiment of the present invention;

FIG. 2 illustrates a drop-in pocket for photocopied and other printed material of one embodiment of the present invention; and

FIG. 3 illustrates a flow diagram of a digital embodiment utilizing the objects of the present invention.

### SUMMARY OF INVENTION

Accordingly, the present invention provides a personal organization system and methods for health care records and the like for humans and animals that overcomes the failings of the prior art. The present invention can provide: increased scope of the types of records maintained; pre- and post-medical or veterinary professional appointment planning; web-based applications and complements; photographic identifiers; storage components (such as for storing photocopied material); safe and confidential transport of health films and slides; and the like.

In one embodiment is provided a health information storage and organization system having a binder having a plurality of dividers defining sections within said binder; a plurality of standardized health forms; an Internet component to facilitate data entry and retrieval and form generation; the Internet component communicatively connected to health care provider databases containing data for retrieval into the system; a carrying case configured to receive the binder, plus data from health care providers; and a portable electronic storage and retrieval device. The system can optionally add at least one drop-in pocket whereby non-system records may be stored, an instruction booklet, and a digital storage device. The storage device can contain computer code and forms to integrate with a user's computer to generate forms and information and access the system's Internet component.

The sections can be identified by data selected from the list comprising: radiology films, electronic data media, laboratory data, demographic information, genetic data, drug information, medical device data, health risk assessments, pathology slides, and tissues.

The dividers may also have a tab with a pre-printed legend.

The present invention also can have a method of organizing health care information comprising the steps of accessing a program to determine user status; importing data as requested; exporting data as requested; signing up for the program as requested; and accessing data stored for public information as requested. Status levels can include: general public, health care provider, user, or system administrator. A user can select from the following options: emergency information, data access, data entry, assigning a guest for access to said user's stored information, and exporting data. A guest may select from the following options: emergency information, predetermined data access, data entry, and exporting predetermined data. The general public may select from the following options: sign-up, general provided health information, partner links, sample forms, contact information, and system demonstration.

Other features of the present invention will become more apparent to persons having ordinary skill in the art to which the present invention pertains from the following description and claims.

### DETAILED DESCRIPTION OF THE INVENTION

The present invention generally relates to a system and method (“system”) of organizing records and, more specifically, to a personal organization system for health care records (which can include information beyond health care information, as described above) and the like for humans and animals (“information”). The objects of the invention may include, in various combinations of paper, digital, web-based, and other various electronic means known in the art, to collect, store, retrieve, organize, and verify such information. The following description is merely exemplary in nature and is in no way intended to limit the present disclosure, application, or uses.

Health care information and the like is the personal property of the consumer and can be organized in a binder or in various electronic and digital formats known in the art (and in various combinations), including the Internet. The information and storage formats such as binder, radiology film, pathology slides, CDs, and the like can be carried in a case in a kit form of the present invention. In this instance, the system is transportable by the consumer. A web-based and/or electronic portion of the present invention system can be employed and would be helpful in, for example, emergency situations when “hard” copies of this information are not readily available. In this instance, information may be physically carried by the user on any electronic storage device known in the art or, alternatively, in combination with access to patient information on the Internet. A system may employ a means to identify a patient, such as an identification card, and information on how to access their available medical information online.

In one embodiment of the present invention, there can be a binder with a Table of Contents, at least two banks of index tab dividers, pre-formatted forms for the user to fill in, document pockets, clear pocket for photo ID, and a carrying case. Additionally, means to store electronic media and/or information to access any Internet components can also be included.

General aspects of one embodiment are detailed below.

A table of contents listing various Sections in the system that can be separated by index tab dividers. For exemplary purpose only, such Section titles can include: General Information, Medical & Family History, Hospitalizations, Medications & Prescriptions, Allergies & Vaccinations, Activity Quickview, Symptom Tracker, Appointment Focus Sheet, Decades Health, Test Results, Insurance & Bills, Calendar, Contact Cards & Correspondence, Specialists, and Research. The General Information section can include a user's contact information, emergency contacts, power of attorney, pharmacy information, and the like. The Medical & Family History Section can include the user's health history and the user's family's health history. The Hospitalizations Section can include the user's operations, emergency room visits, and non-operative hospitalization information. The Medications & Prescriptions Section can include current and past medications and be designed to identify problems, interactions, and adverse reactions. The Allergies & Vaccinations Section can be designed to identify allergies, causes of allergies, vaccination history, and tracks any vaccination adverse reaction. The Symptom Tracker Section can include a form for the user to fill in to inventory their symptoms. This Section and forms can be designed in an easy manner for the non-health care professional user to understand and designed to identify and quantify symptoms in a manner that a health professional performs in a typical interaction with a patient. An Activity Quickview Section can indicate a list of user health-related activities for quick and easy reference. Activities may include a doctor appointment, radiology exam, vaccination, etc. The Decades Health Section can indicate a list of preventative health measures a user can take, grouped according to age. The user can fill in this list with the consultation of their doctor and can prompt a user to ask preventative health questions of their health care provider. The Appointment Focus Sheet Section can indicate a list of health-related questions that the user will use to preplan a health appointment and create actions to follow based on the outcome of the appointment. One Appointment Focus Sheet can be used per one health appointment. The Test Results Section can store photocopies of test results in a document pocket. Examples of test result can include blood tests, radiology reports, pathology reports, and the like. The Insurance & Bills Section can have forms with insurance information and store health-related bills in the document pocket included within this Section. The Calendar, Contact Cards & Correspondence section can have a calendar, a place for contact cards, and any miscellaneous correspondence. The Specialists Section can be customized by a user. A user may designate each one of the specialist sections according to their own medical conditions. For example, if a user has diabetes, they may designate one specialist section for their endocrinologist. A user without this condition may use the section for another condition. And the Research Section can organize information from the user, the health professional, or from another appropriate source. For example, if a user has diabetes, they may include research relevant to diabetes in this section. Basically, many types of information can be included from: transfer information to and from doctor' offices, hospitals, free-standing medical clinics and centers, tertiary care centers, radiation therapy offices, ambulances, veterinary clinics, animal hospitals, schools, camps, prisons, day care centers, eldercare centers, nursing homes, offices, emergency centers, universities, colleges, boarding schools, pet shelters, animal day care, kennels, pet boarding facilities, and the like.

Document pockets can be placed in most sections of the system. The document pocket placed in a particular section can be used to store photocopied material relevant to that section. For example, in the Research Section, a user with diabetes can place printed materials pertaining to the condition. The document pockets obviate the need for holes to be punched into the written materials.

At least two banks (or sets) of index tab dividers will divide the various sections. A first set can have the headings, and a second set can have tabs customized to a specific application. Section-appropriate forms can be preloaded into the system in the appropriate section. The index tab dividers can also have instructions to aid the user, such as how to properly fill in the information on the forms in that particular section.

The forms used in the system can be on any various paper size. A user may add their own forms or those of health care professionals by utilizing the document pocket or creating holes to correspond with the binder rings.

A clear pocket for photo ID can be included in this embodiment, such as on the inside front cover of the binder. As stated above, the ID card can also contain information on how to access the digital or electronic format of selected and predetermined information. Optionally, a separate digital or electronic storage device can be a separate component of the system.

A carrying case can allow the user to place a binder inside for safe and confidential transportation to and from health-related activities. The user may also place inside the carrying case Radiology films, electronic storage devices such as CDs, pathology slides, pathology tissue blocks and other pathology material, and research material. Appropriate interior dividers will allow the items to be placed securely and in an organized fashion.

Other embodiments of the present invention can also use a web-based portion accessible by a user, their designated guest, or the general public. The web portion can allow users to import information, export information, share information, print information, print an emergency medical card with basic health information, make purchases of products for sale, access data, enter data, assign guests, burn disks, have partner links, view sample forms, view general health information, print PDF forms for medication scheduling, and the like.

In an embodiment of the invention intended for health information of a minor, additional items may be included in the table of contents, and additional sections may be created to correspond to the additional items in the table of contents. These may include, but are not limited to, a Child Health Planner, Development, Growth Charts, and Power of Attorney.

In an embodiment of the invention intended for health information of a pet, additional items may be included in the table of contents, and additional sections and subsections may be created to correspond to the additional items in the table of contents. These may include, but are not limited to, lineage information, breed information, behavior information, training information, characteristics, adoptive history, show history, special needs, microchip information, license information, spay/neuter information, photographs, health needs, social requirements, information for pet retrieval, and identification via microchip.

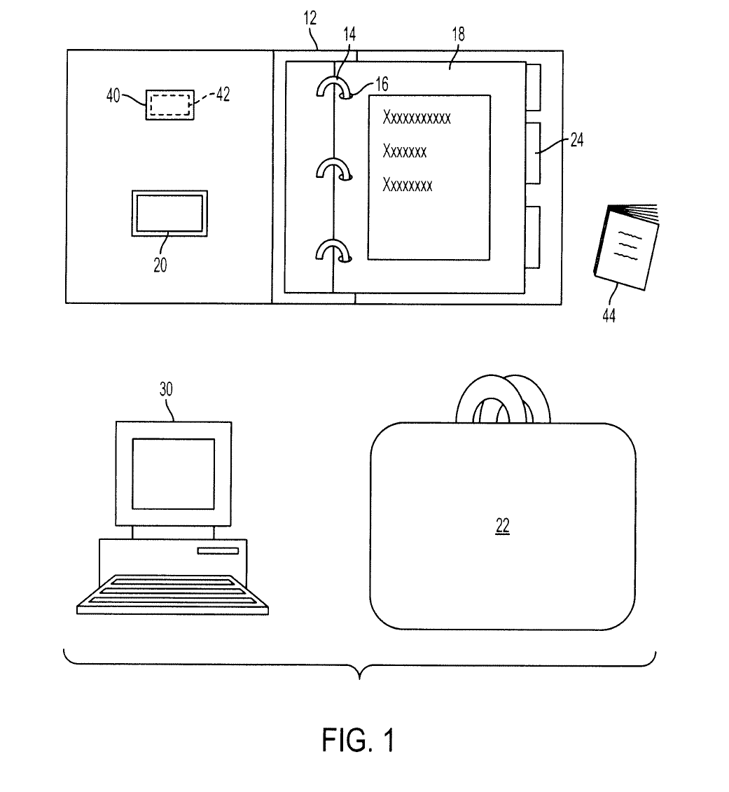

Referring now to the figures, FIG. 1 illustrates one potential health care information system and is generally indicated at 10. System 10 has a binder 12 sized to contain standard paper sizes used in the medical profession, though other sizes may be used and still fall within the scope of the invention. Binder 12 may be assembled from an inflexible or flexible, paper or plastic, material in an unlimited variety of colors. Binder 12 cover may contain a photographically-generated design submitted by the purchasing party or the inventor, illustrated design, or a combination thereof. Cover designs may be both pre-designed and customizable by the user. Customization may include the user's name on the outside or inside of the binder. Both digital and 4-color process printing may be used, but the printing process is not limited to these methods. Newer printing technologies may be used as they become available as the industry evolves. As shown, binder 12 can have rings 14 corresponding to holes 16 on Section dividers 18. Index tabs 24 can also be used.

Instructions for the use of the invention can be included within the tab sections and/or on an accompanying pamphlet. Large print can be optionally employed in all embodiments.

Pre-formatted and preprinted standardized forms can be placed in the tab divider sections instructing the user to write in information, although there is no limitation on the size of the paper. For example, a user may be instructed in a Vaccines section to “write down the date, type of vaccine received, and name of the vaccine provider.” Further instruction to the user may be to “ask the vaccine provider for a photocopy of the vaccination record.”

Optionally, the inside front cover (or anywhere within the system, such as the carrying case, section dividers, or anywhere within the binder) of the binder may contain a see-through holder 20 for a recent photograph of the user, child, or animal for identification purposes. See-through holder 20 can be of any size that fits in the inside front cover. In another embodiment, holder 20 may also be located in the back inside cover. Photographs may also be on the front cover, back cover, spine, or held within the sections of the binder. Similarly, binder 12 can also optionally contain another holder 40 to store and protect an electronic storage device 42, such as a floppy disk, compact disk, Zip drive, and the like. Also, an instruction book 44 may optionally be included with the system and stored in any number of places within binder 12 or carrying case 22.

In another embodiment, the invention can have a web-based component to generate and maintain, in any combination, the health care information described above. The user can be directed to a website that will allow them to enter information that may be printed and kept on their person. The information may include medications, allergies, medical conditions, and the like. The information is entered by the user or their designee and may be printed on their own printer.

The present invention may optionally include a carrying case 22 to allow a user to place inside the binder radiology films, pathology slides and tissues, and CDs containing health information. The carrying case can allow for transportation of the binder, pathology slides, and CDs when transportation of films is required.

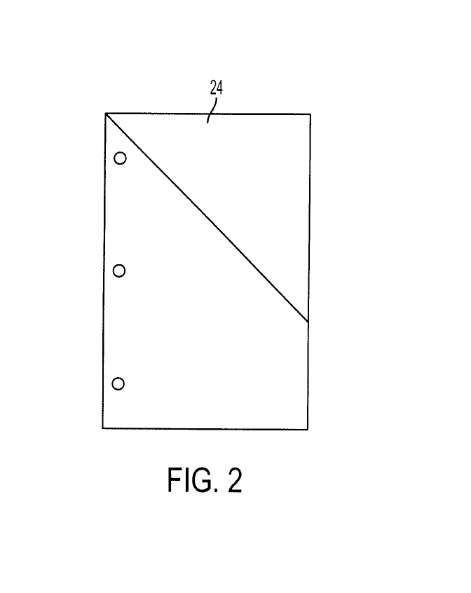

FIG. 2 illustrates a drop-in pocket 24 for photocopied and other printed material of one embodiment of the present invention.

The present invention, in a digital format, can be realized as methods or systems in hardware, software, or a combination of hardware and software of a computer system 30, including a computer network system which may include the Internet. The present invention can be realized in a centralized fashion in one computer system or in a distributed fashion, where different elements are spread across several computer systems. Any kind of computer system or other apparatus adapted for carrying out the methods described herein is suited. A typical combination of hardware and software may include a general purpose computer system with a computer program that, when being loaded and executed, controls the computer system such that it carries out the systems and methods described herein. The present invention may also be voluntarily embedded in a computer program product (or any computer-usable medium having computer-readable program code embodied therein) which comprises all the features, enabling the implementation of the methods and systems described herein and which, when loaded in a computer system, is able to carry out these systems and methods.

Computer program or computer program product, in the present context, means any expression, in any language, code, or notation, of a set of instructions intended to cause a system having an information processing capability to perform a particular function, either directly or after either or both of the following: (a) conversion to another language, code, or notation; and (b) reproduction in a different material or electronic form.

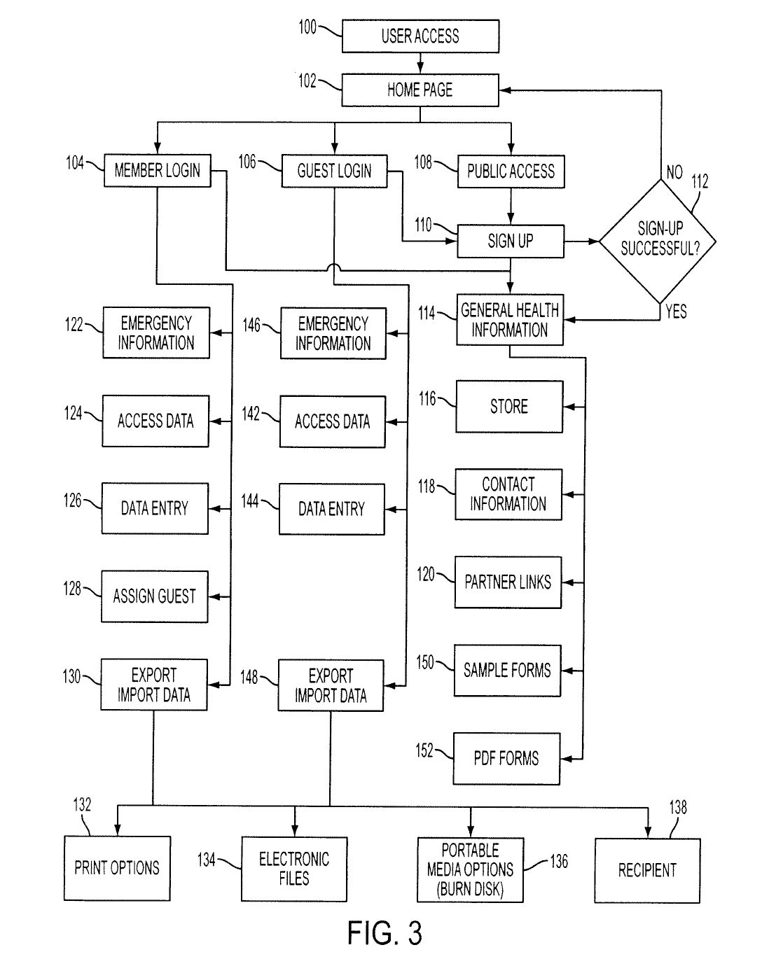

FIG. 3 provides an illustration of a basic flow diagram showing how the systems and methods of the present invention can be practiced as an Internet or web-based application to supplement or replace the binder embodiment above. The system is initiated at step 100, where a user accesses the system and is directed to a publicly-available home page at step 102. Various means may be used at this initial step but, at present, the most likely means would be the Internet. At the access point home page 102, the user can select various options as shown as member login 104, guest login 106, and public access 108. If a user wants to participate in the program, they must select public access 108, where they can be directed to sign up for the program at step 110. Establishing an account can be done by various methods known in the art, such as acceptance of terms and conditions of use, credit check, identification information and verification, and the like. If the acceptance procedure fails, for whatever reason, the system at step 112 returns to step 102. If the acceptance procedure is successful at step 112, the user is now considered a Member User and is directed to input user information at step 114. This would include input of any combination of information that is referenced throughout this description. Once this initial input is completed, the system proceeds to step 116 to store the information in a retrievable format. Additionally, and not by way of limitation, contact information, partner links, sample forms, and PDF forms can be included at steps 118, 120, 150, and 152 respectively. From there, the system can return to step 102 to allow a user to login at step 104 or to allow a guest login 106.

Once a member user is logged in at step 104, they can choose from a variety of options envisioned within the scope of the invention. As shown by way of example, the user may review, update, or add any other additional information not initially added after step 112, including Emergency Information 122, Access Data 124, Data Entry 126, Assign Guest 128, and Export Data 130. At step 128, assigning a guest is to allow non-patient access to the system. The user may pre-select what level of access the guest is entitled, such as read only access, or exclude any other information the user wishes to maintain privacy or integrity of the data, while allowing useful access to health care providers that may need the information, such as in an emergency. If exporting data is selected (Step 130), the user may select from a variety of formats, including those shown, for example, printing 132, electronic 134, disk 136, or to a selected recipient 138. An importing data format, using various technologies known in the art could also be used here.

Once the user completes all steps above, a guest login is possible. A guest could essentially be a user at step 100 and choose guest logging 106 from the home page 102. The type of access to the guest is controlled by the user and predetermined in the member login 104 section of the system. As shown, the guest may view emergency information 140, access other predetermined data 142, date entry (restricted) 144, and exporting of select data 148. Potential guests may be family members, health care proxies, health care providers, laboratories, or hospitals. The member user may choose the type of information each guest user is permitted to view by pre-selecting the items to which they have access.

The member user may select a guest user and assign a guest user password at step 128. The guest user status may be revoked or modified at any time by the member user. Another user option is found at step 108. This step does not involve signing in. Once there, they may choose from options which include, but are not limited to; Sign Up, General Health Information, Store, Contact Information, and Partner Links.

The present invention offers several advantages over the prior art. The drop-in for the binder embodiment of the present invention can include pockets for: photographs or specific imaging results, such as X-Ray, radiology reports, lab tests, consultation reports, correspondence, bills, prescriptions, body metric data, and health condition research. Drop-ins for the present invention may also include specific pockets for pets, such as spay/neuter information, pet identification, and pet information research.

One advantage of the present invention, though, is to provide at least written documents in standard paper formats to allow for superior recordkeeping by creating a margin between, for example, a 3-ring binder portion and the information area of the document, such as written text. Such document headings could include at least any of the documents described herein and in any combination.

Drop-in information holders obviate the requirement of operating the 3-ring mechanism, which may prove difficult for people with physical challenges. They also remove the requirement for the user to utilize a hole-punching device. While 3 rings are submitted, any number may be used. The rings may be of any size. The rings may be opened for the insertion of information that is perforated with coordinated holes.

Additional advantages of the current invention described above are:

Application to health care to humans and animals;

Increased scope and completeness of health care records;

Combination of both a paper and electronic component. The electronic component will contain a printable summary of key data to be carried by the owner of the product or the guardian of the user of the product;

Photographic identification to provide an additional metric for establishing ownership of the product by third parties, such as emergency workers;

A carrying case to include the product, radiology films, pathological slides and tissues;

Optional large print for the vision impaired;

Convenient drop-in pockets for photocopies to obviate the need for a 3-hole puncher;

Pre-labeled tab dividers and additional customizable tab dividers to permit each user to modify the product to their specific specialist; and

Ability for the consumer to personally modify system to better suit their needs.

The description of the present invention herein is presented to enable any person skilled in the art to make and use the invention and is provided in the context of particular applications of the invention and their requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

I claim:

1. A health information storage and organization system, comprising:
a binder, having a plurality of dividers defining sections within said binder;
a plurality of standardized health forms;
an Internet component to facilitate data entry and retrieval and form generation;
the Internet component communicatively connected to health care provider databases containing data for retrieval into the system;
a carrying case configured to receive the binder, plus data from health care provider; and
a portable electronic storage and retrieval device.

2. The system of claim 1, further comprising at least one drop-in pocket, whereby non-system records may be stored.

3. The system of claim 1, further comprising a digital storage device.

4. The system of claim 3, wherein said storage device contains computer code and forms to integrate with a user's computer to generate forms and information and access the system's Internet component.

5. The system of claim 1, wherein sections are identified by data selected from the list comprising: radiology films, electronic data media, laboratory data, demographic information, genetic data, drug information, medical device data, health risk assessments, pathology slides and tissues.

6. The system of claim 1, wherein said plurality of dividers further comprise a tab with a preprinted legend.

7. The system of claim 1, further comprising printed information to assist a user to develop and organize the system.

8. A method of organizing health care information comprising the steps of:
accessing a program to determine accessor's status;
importing data as requested;
exporting data as requested;
signing up for the program as requested; and
accessing data stored for public information as requested.

9. The method of claim 8, wherein the status is selected from the list of general public, health care provider, user, or system administrator.

10. The method of claim 9, wherein if the status is user, said user selects from the following options: emergency information, data access, data entry, assigning a guest for access to said user's stored information, and exporting data.

11. The method of claim 9, wherein if the status is guest, said guest selects from the following options: emergency information, predetermined data access, data entry, and exporting predetermined data.

12. The method of claim 9, wherein if the status is general public, said general public selects from the following options: sign-up, general provided health information, partner links, sample forms, contact information, and system demonstration.
